(19) United States
(12) Patent Application Publication
(10) Pub. No.: US 2014/0282021 A1
(43) Pub. Date: Sep. 18, 2014

(54) Visualization of Communication Between Devices in an Electric Power System

(71) Applicant: SCHWEITZER ENGINEERING LABORATORIES, INC., Pullman, WA (US)

(72) Inventors: David J. Dolezilek, Pullman, WA (US); Jason A. Dearien, Moscow, ID (US); Benjamin S. Day, Pullman, WA (US); Dennis Gammel, Pullman, WA (US); Ryan Bradetich, Pullman, WA (US); Jerry J. Bennett, Pullman, WA (US); Christopher Ewing, Colfax, WA (US)

(73) Assignee: SCHWEITZER ENGINEERING LABORATORIES, INC., Pullman, WA (US)

(21) Appl. No.: 13/840,787

(22) Filed: Mar. 15, 2013

(51) Int. Cl. H04L 12/24

(52) U.S. Cl. CPC H04L 41/22
USPC 715/735

(57) ABSTRACT

Systems and methods are presented for visualizing various devices in an electric power generation and delivery system. In certain embodiments, a method for visualizing communication may include receiving configuration information from an electric power generation and delivery system. Based on the configuration information, a plurality of devices included in the electric power generation and delivery system may be identified. Further, a plurality of communication pathways may be identified. Based on the identified plurality of devices and communication pathways, a visual topology of the electric power generation and delivery system may be generated and displayed.

### TECHNICAL FIELD

This disclosure relates to systems and methods for visualizing various devices in an electric power generation and delivery system, and more particularly, to systems and methods for visualizing communication pathways between devices, configuring devices, and diagnosing potential communication bottlenecks between devices in an electric power generation and delivery system.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a simplified one-line diagram of an electric power generation and delivery system and associated network and intelligent electronic devices (IEDs) consistent with embodiments disclosed herein.

FIG. 2 illustrates examples of device and substation configuration information consistent with embodiments disclosed herein.

FIG. 3 illustrates a system for visualization of devices in an electric power generation and delivery system.

FIG. 4 illustrates a visualization system for device and substation configuration consistent with embodiments disclosed herein.

FIG. 5 illustrates a system for visualizing message traffic between devices in an electric power generation and delivery system.

FIG. 6 illustrates a flow chart of a method for visualization of devices in an electric power generation and delivery system.

FIG. 7 illustrates a flow chart of a method for device and substation configuration consistent with embodiments disclosed herein.

FIG. 8 illustrates a flow chart of a method for visualizing message traffic between devices in an electric power generation and delivery system consistent with embodiments disclosed herein.

FIG. 9 illustrates a block diagram of a device for implementing certain embodiments of the systems and methods disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (ASIC), PAL, PLA, PLD, field programmable gate array (FPGA), or any other customizable or programmable device.

Electrical power generation and delivery systems are designed to generate, transmit, and distribute electrical energy to loads. Electrical power generation and delivery systems may include equipment, such as electrical generators, electrical motors, power transformers, power transmission and distribution lines, circuit breakers, switches, buses, transmission lines, voltage regulators, capacitor banks, and the like. Such equipment may be monitored, controlled, automated, and/or protected using intelligent electronic devices (IEDs) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (PLCs), programmable automation controllers, input and output modules, governors, exciters, statcom controllers, static VAR compensator (SVC) controllers, on-load tap changer (OLTC) controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together.

IEDs may communicate with other IEDs, monitored equipment, and/or network devices using one or more suitable communication protocols and/or standards. In certain embodiments, IEDs, monitored equipment, and/or network devices included in an electric power generation and delivery system may communicate using one or more bandwidth conservative protocols. In further embodiments, IEDs, monitored equipment, and/or network devices included in an electric power generation and delivery system may communicate using one or more less-bandwidth conservative protocols. In certain circumstances, an electric power generation and delivery system may include a first set of IEDs, monitored equipment, and/or network devices that are configured to communicate using one or more bandwidth conservative protocols and a second set that are configured to communicate using one or more less-bandwidth conservative protocols.

In certain embodiments one or more IEDs, monitored equipment, and/or network devices included in an electric power generation and delivery system may communicate using a variety of protocols, such as IEC 61850 GOOSE (Generic Object Oriented Substation Events), SV (Sampled Values, MMS (Manufacturing Messaging Specification), SEL Fast Message (FM), and/or the like. In further embodiments, one or more IEDs, monitored equipment, and/or network devices included in an electric power generation and delivery system may communicate using a Mirrored Bits® protocol, a Distributed Network Protocol (DNP), and or any other suitable communication protocol. In some embodiments, IEC 61850 GOOSE, SV, and MMS or the like may be considered a less-bandwidth conservative communication protocol, whereas Mirrored Bits®, DNP, or the like may be considered bandwidth conservative communication protocols.

IEDs, monitored equipment, and/or network devices may communicate (e.g., transmit and/or receive) messages (e.g., GOOSE, SV, MMS, Mirrored Bits®, FM, and/or DNP messages) that include bits, bit pairs, measurement values, and/or any other relevant data elements. Certain communication protocols (e.g., GOOSE, SV) may allow a message generated from a single device to be transmitted to multiple receiving devices (e.g., subscriber devices and/or particular receiving devices differentiate messages to consume from those it should reject based on parameters designated or identified in a message). Further, network devices may have knowledge has to which ports to prohibit and which ports to allow messages in ingress and egress based on message distribution parameters. Such messages may be referred to as multi-cast messages. A device generating a multi-cast message may be referred to as a publishing device. A device subscribing to messages from a particular publishing device may be referred to as a subscribing device.

In certain embodiments, (e.g., embodiments that utilize GOOSE), a message may be part of a message stream that includes multiple redundant copies of the message and/or similar messages. Messages in the message stream may include one or more control instructions, monitored system data, communications with other IEDs, monitored equipment and/or other network devices, and/or any other relevant communication, message, or data. In further embodiments, messages in the message stream may provide an indication as to a data state (e.g., a measured data state) of one or more components and/or conditions within an electrical power generation and delivery system.

Consistent with embodiments disclosed herein, devices (e.g., IEDs and/or network devices) included in an electric power generation and delivery system may be associated with one or more device configuration files. A device configuration file may include information regarding capabilities of a device, location or address information of a device (e.g., MAC and/or Ethernet address), connectivity of a device relative to other devices (e.g., port connectivity information, information regarding monitored and/or controlled equipment the device is connected to, or the like), and/or the like. In further embodiments, the device configuration file may include information regarding communication capabilities of a device (e.g., an indication of one or more communication protocols the device is capable of understanding including multi-cast messages to which the IED subscribes and those to which it publishes). In certain embodiments, a device configuration file may be a configured IED description (CID) file.

One or more groups of devices included in an electric power generation and delivery system (e.g., a station and/or substation) may be associated with one or more substation configurations files. In certain embodiments, the substation configuration files may include information regarding the capabilities, locations or addresses, interconnectivity, and/or the like, of devices included in the substation. In certain embodiments, a substation configuration file may include multiple device configuration files. In some embodiments, a substation configuration file may be an substation configuration description (SCD) file.

Consistent with embodiments disclosed herein, device configuration files and/or substation configuration files may be utilized to visualize devices and communication channels included in an electrical power generation and delivery system. For example, using device configuration files and/or substation configuration files, systems and methods disclosed herein may generate a visualized communication topology of the corresponding devices and/or substations, providing a user with useful information regarding the topology of an electrical power generation and delivery system. In further embodiments, a visual representation of a communication topology may be utilized to generate corresponding device and/or substation configuration files that can be transmitted and/or imported to corresponding devices. In yet further embodiments, a visualization of devices and/or communication channels may be used to analyze message traffic between the devices and may allow a user to identify potential communication bottlenecks in the electric power generation and delivery system.

FIG. 1 illustrates a simplified diagram of an example of an electric power generation and delivery system 100 consistent with embodiments disclosed herein. The systems and methods described herein may be applied and/or implemented in the system electric power generation and delivery system 100 illustrated in FIG. 1. The electric power generation and delivery system 100 may include, among other things, an electric generator 102, configured to generate an electrical power output, which in some embodiments may be a sinusoidal waveform. Although illustrated as a one-line diagram for purposes of simplicity, an electrical power generation and delivery system 100 may also be configured as a three-phase power system.

A step-up power transformer 104 may be configured to increase the output of the electric generator 102 to a higher voltage sinusoidal waveform. A bus 106 may distribute the higher voltage sinusoidal waveform to a transmission line 108 that in turn may connect to a bus 120. In certain embodiments, the system 100 may further include one or more breakers 112-118 that may be configured to be selectively actuated to reconfigure the electric power generation and delivery system 100. A step down power transformer 122 may be configured to transform the higher voltage sinusoidal waveform to lower voltage sinusoidal waveform that is suitable for delivery to a load 124.

The IEDs 126-138, illustrated in FIG. 1, may be configured to control, monitor, protect, and/or automate the one or more elements of the electric power generation and delivery system. An IED may be any processor-based device that monitors, controls, automates, and/or protects monitored equipment within an electric power generation and delivery system (e.g., system 100). In some embodiments, the IEDs 126-138 may gather status information from one or more pieces of monitored equipment (e.g., generator 102). Further, the IEDs 126-138 may receive information concerning monitored equipment using sensors, transducers, actuators, and the like. Although FIG. 1 illustrates one IED monitoring transmission line 108 (e.g., IED 134) and another IED controlling a breaker (e.g., IED 136), these capabilities may be combined into a single IED.

FIG. 1 illustrates IEDs 126-138 performing various functions for illustrative purposes and does not imply any specific arrangements or functions required of any particular IED. In some embodiments, IEDs 126-138 may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. Further, IEDs 126-138 may be configured to communicate calculations, such as phasors (which may or may not be synchronized as synchrophasors), events, fault distances, differentials, impedances, reactances, frequency, and the like. IEDs 126-138 may also communicate settings information, IED identification information, communications information, status information, alarm information, and the like. Information of the types listed above, or more generally, information about the status of monitored equipment, may be generally referred to herein as monitored system data.

In certain embodiments, IEDs 126-138 may issue control instructions to the monitored equipment in order to control various aspects relating to the monitored equipment. For example, an IED (e.g., IED 136) may be in communication with a circuit breaker (e.g., breaker 114), and may be capable of sending an instruction to open and/or close the circuit breaker, thus connecting or disconnecting a portion of a power system. In another example, an IED may be in communication with a recloser and capable of controlling reclosing operations. In another example, an IED may be in communication with a voltage regulator and capable of instructing the voltage regulator to tap up and/or down. Information of the types listed above, or more generally, information or instructions directing an IED or other device to perform a certain action, may be generally referred to as control instructions.

IEDs 126-138 may be communicatively linked together using a data communications network, and may further be communicatively linked to a central monitoring system, such as a supervisory control and data acquisition (SCADA) system 142, an information system (IS) 144, and/or a wide area control and situational awareness (WCSA) system 140. In certain embodiments, various components of the electrical power generation and delivery system 100 illustrated in FIG. 1 may be configured to generate, transmit, and/or receive messages (e.g. GOOSE messages), or communicate using any other suitable communication protocol. For example, an automation controller 150 may communicate certain control instructions to IED 126 via messages using a GOOSE communication protocol. In certain embodiments, various components of the electrical power generation and delivery system 100 may communicate using one or more bandwidth conservative protocols (e.g., Mirrored Bits®, DNP, FM or the like) and/or one or more less-bandwidth conservative protocols (e.g. GOOSE, MMS).

The illustrated embodiments are configured in a star topology having an automation controller 150 at its center, however, other topologies are also contemplated. For example, the IEDs 126-138 may be communicatively coupled directly to the local SCADA system 142 and/or the WCSA system 140. The data communications network of the system 100 may utilize a variety of network technologies, and may comprise network devices such as modems, routers, switches firewalls, visual private network servers, and the like. Further, in some embodiments, the IEDs 126-138 and other network devices (e.g., one or more communication switches or the like) may be communicatively coupled to the communications network through a network communications interface. In certain embodiments, one or more IEDs 126-138 may be communicatively coupled via a network device 152. For example, IEDs 126, 128 may be communicatively coupled to network device 152, which may in turn be communicatively coupled to automation controller 150. Network device 152 may perform message translation and/or reconfiguration between one or more communication protocols for communications between IEDs 126, 128 and automation controller 150. Network device 152 may further perform message aggregation methods to repackage certain communications generated by IED 126, 128 as a single message for transmission to automation controller 150 (e.g., during periods of high network message traffic and the like).

Consistent with embodiments disclosed herein, IEDs 126-138 may be communicatively coupled with various points to the electric power generation and delivery system 100. For example, IED 134 may monitor conditions on transmission line 108. IEDs 126, 132, 136, and 138 may be configured to issue control instructions to associated breakers 112-118. IED 130 may monitor conditions on a bus 152. IED 128 may monitor and issue control instructions to the electric generator 102, while IED 126 may issue control instructions to breaker 116.

In certain embodiments, communication between and/or the operation of various IEDs 126-138 and/or higher level systems (e.g., SCADA system 142 or IS 144) may be facilitated by an automation controller 150. The automation controller 150 may also be referred to as a central IED, access controller, communications processor, and/or information processor. In various embodiments, the automation controller 150 may be embodied as the SEL-2020, SEL-2030, SEL-2032, SEL-3332, SEL-3378, or SEL-3530 available from Schweitzer Engineering Laboratories, Inc. of Pullman, Wash., and also as described in U.S. Pat. No. 5,680,324, U.S. Pat. No. 7,630,863, and U.S. Patent Application Publication No. 2009/0254655, the entireties of which are incorporated herein by reference.

The IEDs 126-138 may communicate a variety of types of information to the automation controller 150 including, but not limited to, status and control information about the individual IEDs 126-138, IED settings information, calculations made by the individual IEDs 126-138, event (e.g., a fault) reports, communications network information, network security events, and the like. In some embodiments, the automation controller 150 may be directly connected to one or more pieces of monitored equipment (e.g., electric generator 102 or breakers 112-118).

The automation controller 150 may also include a local human machine interface (HMI) 146. In some embodiments, the local HMI 146 may be located at the same substation as automation controller 150. The local HMI 146 may be used to change settings, issue control instructions, retrieve an event report, retrieve data, and the like. The automation controller 150 may further include a programmable logic controller accessible using the local HMI 146. In certain embodiments, systems and methods perform herein may be performed by an automation controller 150 and/or a local HMI 146, although in further embodiments different systems may be used.

In certain embodiments, the automation controller 150 and/or any other system illustrated in FIG. 1 may be further communicatively coupled with one or more remote systems or IEDs including, for example, a remote SCADA system 153 and/or a remote WSCA system 154 via one or more network devices 156, 158 and/or interfaces.

The automation controller 150 may also be communicatively coupled to a time source (e.g., a clock) 148. In certain embodiments, the automation controller 150 may generate a time signal based on the time source 148 that may be distributed to communicatively coupled IEDs 126-138. Based on the time signal, various IEDs 126-138 may be configured to collect and/or calculate time-aligned data points including, for example, synchrophasors, and to implement control instructions in a time coordinated manner. In some embodiments, the WCSA system 140 may receive and process the time-aligned data, and may coordinate time synchronized control actions at the highest level of the electrical power generation and delivery system 100. In other embodiments, the automation controller 150 may not receive a time signal, but a common time signal may be distributed to IEDs 126-138.

The time source 148 may also be used by the automation controller 150 for time stamping information and data. Time synchronization may be helpful for data organization, real-time decision-making, as well as post-event analysis. Time synchronization may further be applied to network communications. The time source 148 may be any time source that is an acceptable form of time synchronization, including, but not limited to, a voltage controlled temperature compensated crystal oscillator, Rubidium and Cesium oscillators with or without a digital phase locked loops, microelectromechanical systems (MEMS) technology, which transfers the resonant circuits from the electronic to the mechanical domains, or a global positioning system (GPS) receiver with time decoding. In the absence of a discrete time source 148, the automation controller 150 may serve as the time source 148 by distributing a time synchronization signal.

To maintain voltage and reactive power within certain limits for safe and reliable power delivery, an electrical power generation and delivery system may include switched capacitor banks (SCBs) (e.g., capacitor 110) configured to provide capacitive reactive power support and compensation in high and/or low voltage conditions within the electrical power system. For example, when power along a transmission line included in the electrical power system meets certain predetermined criteria, the capacitors within the SCB may be switched on (e.g., via breaker 118) by an IED to maintain a proper balance of reactive power. Further, an electrical power generation and delivery system 100 may include an OLTC configured to control the quality of electric power delivered to loads associated with the electrical power system by varying transformer tap positions within the OLTC. Like the SCB, the functionality of the OLTC may be controlled using an IED.

FIG. 2 illustrates examples of device 200, 202 and substation 204 configuration information consistent with embodiments disclosed herein. Particularly, FIG. 2 illustrates examples of device 200, 202 and substation 204 configuration information for certain devices 206-218 included in a substation 220. As illustrated, substation. Although FIG. 2 only illustrates IEDs 206-212 and 216-218 and network device 214 in substation 220, substation 220 may include further IEDs, network devices, and/or any other suitable devices and/or monitored equipment in any configuration.

As discussed above, (e.g., IEDs and/or network devices) may be associated with one or more device configuration files 200, 202. In certain embodiments, device configuration files 200, 202 may be stored locally at respective devices. For example, device configuration file 200, associated with IED 212, may be stored locally at IED 212. In further embodiments, device configuration files 200, 202 may be centrally stored and/or stored in one or more locations. For example, device configuration files 200, 202 may be stored in a separate computer system and/or by a central IED 208 (e.g., an automation controller and/or the like).

Device configuration files 200, 202 may include information regarding capabilities of associated devices 212, 214, location or address information of associated devices 212, 214 (e.g., MAC and/or Ethernet address), connectivity of a associated devices 212, 214 relative to other devices (e.g., port connectivity information, information regarding monitored and/or controlled equipment the device is connected to, or the like), and/or the like. For example, as illustrated, device configuration file 200 associated with IED 212 may include port connectivity information indicating that “Port 1” of IED 212 is communicatively coupled to IED 206. Similarly, device configuration file 202 associated with network device 214 may include port connectivity information indicating that “Port 1” of network device 214 is communicatively coupled to central IED 208 and “Port 2” of network device 214 is communicatively coupled to IED 216. In further embodiments, the device configuration file may include information regarding communication capabilities of a device (e.g., an indication of one or more communication protocols the device is capable of understanding).

Substation configuration file 204 may include information regarding capabilities of the devices (e.g., IEDs 206-212 and 216-218 and network device 214) of substation 220, locations or addresses of the devices, interconnectivity of the devices, and/or the like. For example, as illustrated, substation configuration file 204 may include information indicating that “Port 1” of IED 200 is communicatively coupled with IED 206, that “Port 1” of network device 214 is communicatively coupled with central IED 208, and that “Port 2” of network device 214 is communicatively coupled with IED 216. In certain embodiments, substation configuration file 204 may include all or a portion of information contained in device configuration files (e.g., device configuration files 200, 202) associated with constituent devices 206-218 of substation 220.

In certain embodiments, device configuration files and/or substation configuration files may further include device subscription and/or publication information. For example, a device configuration file may include subscription information indicating that an associated device subscribes to messages (e.g., multi-cast and/or GOOSE messages) published and/or generated by a particular publishing device. For example, a device configuration file associated with central IED 208 may include information indicating that central IED 208 subscribes to messages generated by IED 212. As detailed below, such subscription information may be utilized in analyzing and optimizing message routing between devices.

Consistent with embodiments disclosed herein, device configuration files (e.g., device configuration files 200, 202) and/or substation configuration files (e.g., substation configuration file 204) may be utilized to visualize devices (e.g., devices 206-218) and communication channels included in an electrical power generation and delivery system and/or a station or substation included therein. For example, as discussed in more detail below, device configuration files and/or substation configuration files may be utilized to generate a visualized communication topology of the corresponding devices and/or substations.

FIG. 3 illustrates a system 300 for visualization of devices in an electric power generation and delivery system. Particularly, the system 300 illustrated in FIG. 3, is configured to generate a visual visualization 302 of one or more devices 304-316 included in an electric power generation and delivery system 322 consistent with embodiments disclosed herein. System 300 may be any suitable computer system configured to perform the methods disclosed herein. In certain embodiments, some functionality of system 300 may be included in an IED. Further, although illustrated as a separate system, functionalities of system 300 may be integrated into one or more devices (e.g., network devices and/or IEDs) included in the electric power generation and delivery system 322.

System 300 may be communicatively coupled with certain elements and/or devices (e.g., IEDs and/or network devices) included an electric power generation and delivery system 322 and/or any portions thereof. For example, system 300 may be communicatively coupled with certain elements and/or devices included in one or more substations of electric power generation and delivery system 322. As illustrated, system 300 may be communicatively coupled with elements and/or devices included in electric power generation and delivery system 322 via a communications network 320. The communications network 320 may include a variety of network technologies, and may comprise network devices such as modems, routers, switches firewalls, virtual private network servers, and the like. Further, the communications network 320 may employ one or more of communication protocols including, for example, GOOSE, Ethernet, Mirrored Bits®, DNP, and/or the like to facilitate communication between system 30 and elements and/or devices included electric power generation and delivery system 322.

As illustrated, via communications network 320, system 300 may receive device and/or substation configuration information 318 (e.g., files) from devices included in electric power generation and delivery system 322. In certain embodiments, the device and/or substation configuration information 318 may be transmitted to system 300 by the devices themselves. In further embodiments, such information may be received from originating devices, aggregated, and transmitted to system 300 by one or more systems and/or IEDs included in electric power generation and delivery system 322.

After receiving the device and/or substation configuration information 318, system 300 may analyze and utilize the information to generate a visualization 302 of one or more devices associated with the received device and/or substation configuration information 318. In certain embodiments, the visualization 302 may provide information regarding a communication topology of the corresponding devices. For example, using port connectivity information included in the device and/or substation configuration information 318, system 300 may determine how devices associated with the device and/or substation configuration information 318 are communicatively connected. In further embodiments, other types of information included in the device and/or substation configuration information 318 may be utilized to determine device communication topologies and/or configure network devices to prohibit and/or allow messages to ingress and egress ports based on message distribution parameters.

In certain embodiments, as illustrated in FIG. 3, the visualization 302 may be presented as a visual topology showing the manner in which the devices are communicatively connected. In some embodiments, such a visual visualization 302 may be presented to a user via an interface (e.g., a display or the like) of system 300. Using the visual visualization 302, a user may analyze communication pathways between devices 304-316 associated with the device and/or substation configuration information 318 and, as discussed below in reference to FIG. 5, analyze message traffic and/or potential communication bottlenecks between such devices 304-316. For example, a user may interact with the visual visualization 302 to view specific device and/or communication pathway configuration settings by selecting one or more devices and/or communication pathways included in the visual visualization.

FIG. 4 illustrates a visualization system 400 for device and substation configuration consistent with embodiments disclosed herein. Particularly, FIG. 4 illustrates a visualization system 400 configured to generate device and/or substation configuration information 402 based, at least in part, on a visual communication topology defined by a user using an interface 424 of the system 400. System 400 may be any suitable computer system configured to perform the methods disclosed herein. In certain embodiments, some functionality of system 400 may be included in an IED. Further, although illustrated as a separate system, functionalities of system 400 may be integrated into one or more devices (e.g., network devices and/or IEDs) included in an electric power generation and delivery system 406.

In certain embodiments, device and/or substation configuration information 402 may be utilized by devices of an electric power generation and delivery system 406 to coordinate automation, control, and protection activities. For example, in some embodiments, device and/or substation configuration information 402 may be utilized by devices of an electric power generation and delivery system 406 to identify communication channels and/or pathways between devices and properly route communications (e.g., messages) between such devices. In further embodiments, device and/or substation configuration information 402 may be used by an IED in determining one or more actions to protect electric power generation and delivery system 406 from damage caused by an undesirable system event.

Device and/or substation configuration information 402 may, in certain embodiments, be generated and/or programmed at the device and/or substation level. For example, each device included in the electric power generation and delivery system 406 may be programmed with corresponding device configuration information including subscription or publication information and port connectivity information. Programming each device and/or substation independently, however, may take considerable time. Accordingly, consistent with embodiments disclosed herein, device and/or substation configuration information 402 may be generated by system 400 based, at least in part, on a visual topology of corresponding devices defined by a user using an interface 424 of the system 400. Generated device and/or substation configuration information 402 may be transmitted and imported into corresponding devices in the electric power generation and delivery system 406.

As illustrated, a user may utilize an interface 424 of system 400 to create a topology of one or more devices included in the electric power generation and delivery system. For example, a user may place one or more devices at various locations in the interface 424 (e.g., IEDs 408-412, 416-420 and network device 414) corresponding to relative locations of the devices 408-420 in the electric power generation and delivery system 406. Further, a user may define one or more communication channels and/or pathways between devices 408-420 in the interface. For example, as illustrated, a user may define communication pathways indicating that central IED 410 is communicatively coupled with IED 408, network device 414, and IED 416. In certain embodiments, the one or more communication channels may represent communication channels between specific ports of devices 408-420 included in the electric power generation and delivery system 406.

In certain embodiments, a user may interact with interface 424 using a cursor 422, a pointing device, a keyboard, and/or any other suitable input or interface device. In some embodiments, the interface 424 may display one or more menus facilitating interaction between the user and the interface 424. For example, as illustrated, the interface 424 may include a device menu 426 configured to allow a user to drag and drop icons corresponding to certain devices (e.g., central IEDs, IEDs, network devices, and/or the like) using cursor 422 into areas of the interface 424 for configuration. Similarly, menus may be utilized by a user in defining other types of device and/or substation configuration information 402 associated with devices 408-420 including, for example, device publication or subscription information, communication protocol information, and/or the like.

After defining the topology and associated configuration information of devices 408-420 included in electric power generation and delivery system 406 in interface 424, system 400 may generate corresponding device and/or substation configuration information 402 (e.g., by selecting an appropriate button or menu 428 on interface 424 or the like). Once generated, the device and/or substation configuration information 402 may be transmitted (e.g., via network 404) and imported into corresponding devices in the electric power generation and delivery system 406. Generating device and/or substation configuration information 402 using system 400 may be more efficient than programming each device and/or substation individually, and may allow a user more configuration flexibility.

In certain embodiments, system 400 may be utilized to generate configuration information for network devices and/or IEDs included in system 504 to optimize message routing in the system 504. In certain circumstances, a network device may distribute multi-cast messages (e.g., multi-cast GOOSE messages) received from an IED to all communicatively connected devices, regardless of whether such devices subscribe to messages generated by the publishing device. Such behavior may result in unnecessary message traffic, as devices that do not subscribe to messages generated by the publishing device will receive multi-cast messages that they do not wish to receive.

To increase efficiency of message distribution, routing, and traffic in the electric power generation and delivery system 406, system 400 may utilize message distribution information associated with multi-cast messages published by devices 408-420 (e.g., message distribution and subscription information provided by a user) to generate configuration information that may be utilized to efficiently distribute and route messages in system 406. For example, using subscription information, system 400 may determine that a network device is connected to an IED subscribing to one or more messages generated by a particular publishing IED at a first port of the network device. Devices coupled with other ports of the network device may not subscribe to and or all messages generated by the publishing IED. Using this information, system 400 may generate configuration information for the network device that configure the network device to only distribute and route appropriate messages from the publishing IED to the subscribing IED at its first port. Such message “trimming” or “pruning” may reduce overall message traffic between devices 408-420 of electric power generation and delivery system 406, and may result in more efficient communication between devices in the system.

FIG. 5 illustrates a system 500 for visualizing message traffic between devices in an electric power generation and delivery system 504. Particularly, the system 500 illustrated in FIG. 5, is configured to generate a visual visualization 506 of message traffic between one or more devices 508-520 included in an electric power generation and delivery system 504 consistent with embodiments disclosed herein. System 500 may be any suitable computer system configured to perform the methods disclosed herein. In certain embodiments, some functionality of system 500 may be included in an IED. Further, although illustrated as a separate system, functionalities of system 500 may be integrated into one or more devices (e.g., network devices and/or IEDs) included in the electric power generation and delivery system 504.

System 500 may be communicatively coupled with certain elements and/or devices (e.g., IEDs and/or network devices) included in electric power generation and delivery system 504 and/or any portions thereof. For example, system 504 may be communicatively coupled with certain elements and/or devices included in one or more substations of electric power generation and delivery system 504. As illustrated, system 500 may be communicatively coupled with elements and/or devices included in electric power generation and delivery system 504 via a communications network 503. The communications network 503 may include a variety of network technologies and utilize a variety of communication protocols to facilitate communication between system 500 and elements and/or devices included electric power generation and delivery system 504.

System 500 may receive device and/or substation configuration information 502 (e.g., files) from devices included in electric power generation and delivery system 504. In certain embodiments, the device and/or substation configuration information 502 may be transmitted to system 500 by the devices themselves. In further embodiments, such information may be received from originating devices, aggregated, and transmitted to system 500 by one or more systems and/or IEDs included in electric power generation and delivery system 504.

After receiving the device and/or substation configuration information 502, system 500 may analyze and utilize the information to generate a visualization 506 of one or more devices associated with the received device and/or substation configuration information 502. In certain embodiments, the visualization 506 may provide information regarding a communication topology of the corresponding devices. For example, using port connectivity information included in the device and/or substation configuration information 502, system 500 may determine how devices associated with the device and/or substation configuration information 502 are communicatively connected and/or with which specific messages. In further embodiments, other types of information included in the device and/or substation configuration information 502 may be utilized to determine device communication topologies.

As illustrated, the visualization 506 may be presented as a visual topology of showing the manner in which the devices 508-520 associated with the device and/or substation communication information 502 are communicatively connected. In some embodiments, a visual visualization 506 may be presented to a user via an interface (e.g., a display or the like) of system 500. Using the visual visualization 506, a user may analyze communication pathways between devices 508-520.

Using visualization 506, a user may further simulate and analyze message traffic between devices 508-520. In certain embodiments, subscription information associated with devices 508-520 may be used in conjunction with visualization 506 to simulate and analyze message routing through devices 508-520. For example, central IED 510 may subscribe to one or more messages generate by IED 520. Using visualization 506, a system 500 may determine that one or more communication pathways exist for messages generated by IED 520 to reach central IED 510. Particularly, as illustrated, communication pathways 526, 530, and 532 in conjunction with IEDs 518 and 512 may be utilized to route appropriate messages published by IED 520 to central IED 510.

In some embodiments, determining that one or more functioning communication pathways exist between publishing devices and subscribing devices may involve analyzing whether communication pathways between devices support the same communication protocols. If a particular communication pathway does not support the same protocol, system 500 may provide one or more recommendations as to one or more devices configured to perform message translation and proxying messages and locations for installing such devices to facilitate proper message routing.

Potential communication bottlenecks may be identified by system 500 using visualization 506. For example, in certain embodiments, system 500 may identify one or more communication pathways in visualization 506 having low bandwidth and/or message processing and transmission capability in view of potential message traffic that may be routed through such pathways. Using this information, a user of system 500 may be able to upgrade certain communication pathways in electric power generation and delivery system 504 to mitigate potential communication bottlenecks.

In certain embodiments, system 500 may identify whether sufficient redundant communication pathways exist between devices 508-520. In certain embodiments, identifying whether sufficient redundant communication pathways exist may allow a user to make changes to electric power generation and delivery system 504 that allow for more robust message routing. For example, system 500 may determine that the only communication pathway between IED 520 and other devices 508-518 is pathway 526. Accordingly, if pathway 526 were to experience an interruption, communications from IED 520 may be interrupted. To ensure most robust communication between IED 520 and other devices 508-518, system 500 may provide one or more recommended redundant communication pathways to the user. For example, system 500 may identify pathway 524 as a possible redundant communication pathway for IED 520. Similarly, system 500 may identify pathway 522 as a possible redundant communication pathway for IED 514. Using this information, a user may take action to integrate such redundant communication pathways in electric power generation and delivery system 504, thereby ensuring more robust communication between devices in system 504.

Although illustrated as separate systems, functionality of system 300 of FIG. 3, system 400 of FIG. 4, and system 500 of FIG. 5 may be integrated into a single system and/or IED. Accordingly, a single system may be capable of device topology visualization, device configuration, and message traffic visualization consistent with embodiments disclosed herein.

FIG. 6 illustrates a flow chart of a method 600 for visualization of devices in an electric power generation and delivery system. Particularly, the illustrated method 600 may be performed by systems and/or devices that, in certain embodiments, may incorporate features of the systems illustrated in FIGS. 3-5. At 602, a system (e.g., a computer system and/or an IED) may receive configuration information from one or more devices included in an electric power generation and delivery system. The configuration information may include device and/or substation configuration files. In certain embodiments, the configuration information may include information regarding capabilities of a device, location or address information of a device (e.g., MAC and/or Ethernet address), connectivity of a device relative to other devices (e.g., port connectivity information, information regarding monitored and/or controlled equipment the device is connected to, or the like), communication capabilities of a device, subscription information, and/or the like. In further embodiments, the configuration information may include information regarding communication capabilities of a device (e.g., an indication of one or more communication protocols the device is capable of understanding). In certain embodiments, the configuration information may include one or more CIDs.

Based on the received configuration information, at 604, the system may identify one or more devices included in the electric power generation and delivery system associated with the configuration information. In certain embodiments, the one or more identified devices may include network devices, IEDs, and/or monitored equipment. At 606, the system may further identify one or more communication pathways between the devices identified at 602 based on the configuration information.

At 608, a visual topology (e.g., a visual visualization) may be generated by the system based on the identified devices and communication pathways associated with the configuration information. In some embodiments, the visual topology may be presented to a user via an interface of a system performing method 600. Using the visual topology, a user may analyze devices and/or communication pathways between devices associated with the configuration information received at 602.

FIG. 7 illustrates a flow chart of a method 700 for device and substation configuration consistent with embodiments disclosed herein. Particularly, the illustrated method 700 may be performed by systems and/or devices that, in certain embodiments, may incorporate features of the systems illustrated in FIGS. 3-5. At 702, a system may receive from a user and indication of a plurality of devices included in an electric power generation and delivery system. In certain embodiments, the indication may include a number of devices, one or more types of devices, communication capabilities of the devices, device settings, and/or the like.

At 704, the system may receive from the user an indication of a plurality of communication pathways and/or channels included in the electric power generation and delivery system. In some embodiments, the indication may include port connectivity information between devices, communication protocol information, communication pathway bandwidth and/or capacity information, and/or the like. In certain embodiments, the indications received at 702 and 704 may be received via a user interface of the system in response to user input. For example, a user may utilize a keyboard, a visual interface, a pointing device, and/or any other suitable interface device to provide the indications.

Using the received indications, at 706, the system may generate device configuration information associated with the plurality of devices. The device configuration information may include device and/or substation configuration files. In certain embodiments, the configuration information may include information regarding capabilities of a device, location or address information of a device (e.g., MAC and/or Ethernet address), connectivity of a device relative to other devices (e.g., port connectivity information, information regarding monitored and/or controlled equipment the device is connected to, or the like), communication capabilities of a device, subscription information, and/or the like. In further embodiments, the configuration information may include information regarding communication capabilities of a device (e.g., an indication of one or more communication protocols the device is capable of understanding). In certain embodiments, the configuration information may include one or more CIDs.

At 708, the generated configuration information may be transmitted to one or more of the plurality of devices. Using the transmitted configuration information, at 710, the one or more of the plurality of devices may be configured. By generating device and/or substation configuration information using method 800, devices may be more efficiently programmed and/or configured and a user may be allowed more device configuration flexibility.

FIG. 8 illustrates a flow chart of a method 800 for visualizing message traffic between devices in an electric power generation and delivery system consistent with embodiments disclosed herein. Particularly, the illustrated method 800 may be performed by systems and/or devices that, in certain embodiments, may incorporate features of the systems illustrated in FIGS. 3-5. At 802, a system (e.g., a computer system and/or an IED) may receive configuration information from one or more devices included in an electric power generation and delivery system. The configuration information may include device and/or substation configuration files. In certain embodiments, the configuration information may include information regarding capabilities of a device, location or address information of a device (e.g., MAC and/or Ethernet address), connectivity of a device relative to other devices (e.g., port connectivity information, information regarding monitored and/or controlled equipment the device is connected to, or the like), communication capabilities of a device, subscription information, and/or the like. In further embodiments, the configuration information may include information regarding communication capabilities of a device (e.g., an indication of one or more communication protocols the device is capable of understanding). In certain embodiments, the configuration information may include one or more CIDs.

Based on the received configuration information, at 804, the system may identify one or more devices included in the electric power generation and delivery system associated with the configuration information. In certain embodiments, the one or more identified devices may include network devices, IEDs, and/or monitored equipment. At 806, the system may further identify one or more communication pathways between the devices identified at 602 based on the configuration information.

At 808, a visual topology (e.g., a visual visualization) may be generated by the system based on the identified devices and communication pathways associated with the configuration information. The generated visual topology may be displayed to a user, at 810, on an interface of the system performing method 800. Once displayed, at 812, message traffic between devices along communication pathways included in the visual topology may be simulated. For example, possible message routing pathways between a publishing device and/or one or more subscribing devices may be displayed. Similarly, redundant communication pathways may be identified and/or be recommended by the system. In further embodiments, real time communication paths and/or communication bottlenecks (e.g., communication pathways handling message traffic from a larger number of devices) may be identified. By simulating message traffic conditions between devices in an electric power generation and delivery system using method 800, a user may improve and/or optimize message routing and traffic in the system.

FIG. 9 illustrates a block diagram of a computer system 900 for implementing certain embodiments of the systems and methods disclosed herein. In certain embodiments, the computer system 900 may be a network device, network switch, modem, router, firewall, virtual private network server, and/or and any other suitable network device or system. Further embodiments may be implemented in an IED. As illustrated, the system 900 may include a processor 902, a random access memory (RAM) 904, a communications interface 906, a user interface 908, and/or a non-transitory computer-readable storage medium 910. The processor 902, RAM 1104, communications interface 906, user interface 908, and non-transitory computer-readable storage medium 910 may be communicatively coupled to each other via a common data bus 912. In some embodiments, the various components of the network device 900 may be implemented using hardware, software, firmware, and/or any combination thereof.

The user interface 908 may be used to control certain features of the network device 900 (e.g., via any suitable interactive interface to a user, one or more visual or audible status indicators, and/or the like). The user interface 908 may be integrated in the network device 900 or, alternatively, may be a user interface for a laptop or other similar device communicatively coupled with the computer system 900. In certain embodiments, the user interface 908 may be produced on a touch screen display. In certain embodiments implementing systems and methods described above, the user interface 908 may be used to display visual visualizations of communication topologies. The communications interface 906 may be any interface capable of communicating with other computer systems and/or other equipment (e.g., remote network equipment) communicatively coupled to computer system 900.

The processor 902 may include one or more general purpose processors, application specific processors, microcontrollers, digital signal processors, FPGAs, or any other customizable or programmable processing device. The processor 902 may be configured to execute computer-readable instructions stored on the non-transitory computer-readable storage medium 910. In some embodiments, the computer-readable instructions may be computer-executable functional modules 914, 916, 918. For example, the computer-readable instructions may include a device visualization module 914 configured to implement certain visualization methods disclosed herein, a configuration module 916 configured to implement certain device configuration methods disclosed herein, and/or a message visualization module 918 configured to implement certain message traffic analysis and visualization methods disclosed herein. Other functional modules configured to implement all or part of the functionality of the systems and methods described above in reference to FIGS. 1-8 may also be included.

While specific embodiments and applications of the disclosure have been illustrated and described, it is to be understood that the disclosure is not limited to the specific configurations and components disclosed herein. Accordingly, many changes may be made to the details of the above-described embodiments without departing from the underlying principles of this disclosure. The scope of the present invention should, therefore, be determined only by the following claims.

What is claimed is:

1. A method for visualizing communication in an electric power generation and delivery system performed by a visualization system, the method comprising:
receiving, at an interface of the visualization system, configuration information from an electric power generation and delivery system;
identifying, based on the configuration information, a plurality of devices included in the electric power generation and delivery system;
identifying, based on the configuration information, a plurality of communication pathways between the plurality of devices included in the electric power generation and delivery system;
generating, based on the identified plurality of devices and communication pathways, a visual topology of the plurality of devices and the plurality of communication pathways; and
displaying the visual topology on an interface of the visualization system.

2. The method of claim 1, wherein the configuration information comprises one or more device configuration files.

3. The method of claim 1, wherein the configuration information comprises one or more substation configuration files.

4. The method of claim 1, wherein configuration information comprises port connectivity information.

5. The method of claim 1, wherein the configuration information comprises device address information.

6. The method of claim 1, wherein the method further comprises displaying on the interface of the visualization system message traffic distribution and routing information.

7. The method of claim 6, wherein the message traffic distribution and routing information comprises an indication of a communication bottleneck in the electric power generation and delivery system.

8. The method of claim 6, wherein the message traffic distribution and routing information comprises an indication of a redundant communication pathway between the plurality of devices.

9. A non-transitory computer-readable storage medium storing instructions that, when executed by a processor, cause the processor to:
receive configuration information from an electric power generation and delivery system;
identify, based on the configuration information, a plurality of devices included in the electric power generation and delivery system;
identify, based on the configuration information, a plurality of communication channels between the plurality of devices included in the electric power generation and delivery system;
generate, based on the identified plurality of devices and communication channels, a visual topology of the plurality of devices and the plurality of communication channels; and
display the visual topology on an interface of a visualization system.

10. The non-transitory computer-readable storage medium of claim 9, wherein the instructions further cause the processor to display on the interface of the visualization system message traffic routing information.

11. The non-transitory computer-readable storage medium of claim 10, wherein the traffic routing information comprises an indication of a communication bottleneck in the electric power generation and delivery system.

12. The non-transitory computer-readable storage medium of claim 10, wherein the message traffic routing information comprises an indication of a redundant communication pathway between the plurality of devices.

13. A method for configuring devices included in an electric power generation and delivery system, the method comprising:
receiving, via a user interface of a device configuration system, an indication of a plurality of devices included in the electric power generation and delivery system;
receiving, via the user interface, an indication of a plurality of communication pathways between the plurality of devices included in the electric power generation and delivery system;
generating, based on the received indication of the plurality of devices and indication of the plurality of communication pathways, device configuration information for the plurality of devices;
transmitting, via a communications interface of the device configuration system, the generated device configuration information to one or more of the plurality of devices; and
configuring the one or more of the plurality of devices based on the generated device configuration information.

16. The method of claim 13, wherein the generated device configuration information comprises port connectivity information.

17. The method of claim 13, wherein the generated device configuration information comprises device subscription information.

18. The method of claim 13, wherein configuring the one or more of the plurality of devices further comprises configuring at least one device of the plurality of device to distribute and route multi-cast messages from a publishing device received by the at least one device only to devices subscribing to the messages from the publishing device.

19. A non-transitory computer-readable storage medium storing instructions that, when executed by a processor, cause the processor to:
receive an indication of a plurality of devices included in the electric power generation and delivery system;
receive an indication of a plurality of communication pathways between the plurality of devices included in the electric power generation and delivery system;
generate, based on the received indication of the plurality of devices and indication of the plurality of communication pathways, device configuration information for the plurality of devices; and
transmit the generated device configuration information to one or more of the plurality of devices.

20. The non-transitory computer-readable storage medium of claim 19, wherein the generated device configuration information comprises device subscription information, and wherein the generated device configuration information is configured to direct at least one device of the plurality of device to route multi-cast messages from a publishing device received by the at least one device only to devices subscribing to the messages from the publishing device.
